(19) United States
(12) Patent Application Publication
(10) Pub. No.: US 2008/0147915 A1
(43) Pub. Date: Jun. 19, 2008

(54) Management of memory buffers for computer programs

(76) Inventor: Alexander Kleymenov, Novosibirsk (RU)

Correspondence Address: INTEL/BLAKELY, 1279 OAKMEAD PARKWAY, SUNNYVALE, CA, 94085-4040, US

(21) Appl. No.: 11/541,064

(22) Filed: Sep. 29, 2006

(51) Int. Cl. G06F 5/00

(52) U.S. Cl. 710/52

(57) ABSTRACT

A method and apparatus for management of memory buffers for computer programs. An embodiment of a method includes executing a computer program, the computer program including one or more threads. A buffer pool is created to hold one or more memory buffers for the operation of the computer program. Upon receipt of a request for a memory buffer from a thread of the computer program, a memory buffer from the buffer pool is provided to the thread if a memory buffer is available in the buffer pool.

### FIELD

Embodiments of the invention relate to computer program operations. More particularly, embodiments of the invention relate to management of memory buffers for computer programs.

### BACKGROUND

In computer operations, certain processes require the usage of multiple memory buffers, which can result in significant memory usage and processor time if the processes are repeated many times. A process that requires multiple large temporal buffers for various operations may result in memory usage that continues to grow in size if the reuse of memory (through garbage collection or similar memory reclamation processes) is unavailable or is not capable of maintaining pace with the memory allocation.

For example, security protocol operations may require allocation of memory for a number of different processes. In a specific example, authentication and communications privacy between a client and server using Secure Sockets Layer protocol (referred to herein as SSL protocol), which is also referred to as Transport Layer Security (TLS) in later versions of the protocol, requires the use of large byte arrays with each of several processes. In the operation of an application, a large number of threads may be utilizing the security protocol, resulting in the allocation of many memory buffers.

If too much memory is tied up in use, the performance of the system may be reduced, or the system may eventually fail because of the excessive memory usage. The execution environment in which a computer application is implemented will determine how and if the allocated memory may be reclaimed and how quickly this process will occur. The reclamation of memory in an execution environment may be insufficient to keep pace with the allocation of needed memory buffers.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 is a block diagram illustration of an embodiment of processes for two threads in a multi-threaded application;

FIG. 2 is a flowchart to illustrate an embodiment of the provision of memory buffers to a computer program;

FIG. 3 illustrates an embodiment of a thread making an initial request for a memory buffer;

FIG. 4 illustrates an embodiment of a thread releasing a memory buffer and requesting a second memory buffer;

FIG. 5 illustrates an embodiment of a second thread retrieving a memory buffer previously released by a first thread;

FIG. 6 illustrates an embodiment of a second thread releasing a first buffer to a buffer pool and reusing a second buffer from the buffer pool;

FIG. 7 illustrates an embodiment of a buffer pool after active threads have finished executing;

FIG. 8 is a line graph illustrating the time and resource usage of a multi-threaded program in an embodiment of the invention;

FIG. 9 is an illustration of multiple SSL connections utilizing an embodiment of a buffer pool;

FIG. 10 is an illustration of an embodiment of a buffer pool for SSL transactions; and

FIG. 11 is a block diagram of an embodiment of a computer system to implement an embodiment of a buffer pool.

### DETAILED DESCRIPTION

An embodiment of the invention concerns management of memory buffers for computer programs.

As used herein:

“Memory buffer” means a portion of memory that is allocated for a particular purpose or use. Memory buffers may include a “temporal buffer”, which is a memory buffer that is allocated for an intermediate computer operation and that is no longer needed after conclusion of the operation.

“Buffer pool” means a memory structure or storage to hold one or more memory buffers.

“Execution environment” means an operating system, virtual machine, or other type of computer environment for the execution of a computer application.

In an embodiment of the invention, a computer program utilizes a buffer pool to manage the use of memory buffers. In an embodiment of the invention, a computer program requires the use of multiple memory buffers. A buffer pool for a computer application stores one or more memory buffers while the memory buffers are not in use by the computer application. In an embodiment, when the application requires a memory buffer for an operation the application provides a request to a buffer pool. Upon receipt of the request, the buffer pool determines whether a memory buffer is available in the buffer pool for the operation. If so, the memory buffer is retrieved from the buffer pool for use by the application. If a memory buffer is not available, then a new memory buffer is generated. After the end of the operation, the application releases the memory buffer back to the buffer pool, and the memory buffer is then available for future requests. The buffer pool allows reuse of temporal memory buffers required for multiple operation, thereby reducing memory usage and CPU (central processing unit) time required for the allocation of memory buffers. The buffer pool may be structured in memory in various ways including, but not limited to, a linked list and a tree structure.

In an embodiment of the invention, a buffer pool created to store memory buffers may work in conjunction with a buffer manager to control the use of buffers. The buffer manager controls the operation of the buffer pool, and manages the allocation, retrieval, release, and deallocation of memory buffers. In an embodiment of the invention, a request for a memory buffer may be made to the buffer manager, which will determine if a memory buffer meeting the requirements of the request is available.

In an embodiment of the invention, a request for a memory buffer may include one or more characteristics required for the memory buffer. In an embodiment, one or more such characteristics may be specified as defaults at the stage of creation of the buffer pool, and thus may be omitted from a request. In a particular example, the request may include a size for the memory buffer. In an embodiment, the requested size may be a minimum size that is sufficient for operation and any memory buffer of the requested size or larger would be sufficient for the request. In one implementation, one possible size that may be requested is a maximum size, with the maximum size being a particular size that will be sufficient for any operation of the application. In addition, while this description illustrates a single buffer pool, other embodiments may utilize multiple buffer pools or buffer pools that are divided in some manner.

In an embodiment of the invention, when an application has completed use of a memory buffer the memory buffer is released back to the buffer pool, where the memory buffer is maintained for use for other operations of the computer application. The memory buffers that are contained in the buffer pool are not subject to garbage collection and are retained for repeated use. When the need for the memory buffers has ended, the buffer pool can be terminated, and the memory buffers can be deallocated. The need for the memory buffers may end when the application ends or when the uses for the memory buffers end. In an embodiment of the invention, a system may also deallocate memory buffers without terminating the buffer pool. For example, the system may deallocate a buffer if the buffer hasn't been used for an extended period of time, or if the number of memory buffers should be reduced for any reason.

In an embodiment of the invention, a buffer pool is created when a first request for a memory buffer is made. However, this process may be varied in other embodiments. For example, a buffer pool may be created when an application is commenced, or may be created when a specific request for the creation of a buffer pool is made. In an embodiment of the invention, memory buffers become available as the buffers are requested, with the first memory buffer being allocated upon receipt of the first request for a buffer. This process may vary in different embodiments. In one example, one or more temporal buffers may be generated and placed in the buffer pool in anticipation of the requirements of the application.

In an embodiment of the invention, a security protocol is utilized by a computer application. The security protocol may include, but is not limited to, SSL protocol. (See TLS Protocol, Version 1.0, Internet Society, RFC 2246 (January 1999); Transport Layer Security (TLS) Protocol Version 1.1, Internet Society, RFC 4346 (April 2006)) In one example, a multi-threaded program may run endpoint authentication and communications privacy between a client and server using the SSL protocol. The SSL protocol is used to organize a secure communication channel between remote peers. One of the subparts of TSL/SSL protocol is an SSL Record protocol, which is placed over the transport protocol and intended to secure the incoming and outgoing data of clients, which includes application data, handshake data, and other data transmitted. The operation of the protocol for incoming data on each of the peers includes: (1) receiving the data from a network transport mechanism (from a TCP/IP Socket or a transport engine), (2) decrypting the received data, (3) verifying the received data, (4) deriving the client's data (including handshake and application data) from the received and decrypted SSL packet, and (5) passing the client's data to the client's data stream. For outgoing data the operation includes: (1) receiving data from the client's data stream, (2) compose an SSL packet for transmission, (3) encrypt the data, and (4) passing the encrypted data to the net transport. However, the operation of the SSL protocol may require the use of a separate temporal buffer for multiple processes. In particular, the Java API (application program interface) that is utilized for SSL protocol implemented on a Java platform requires the use of a separate memory buffer for each relevant operation of an SSL transaction. A Java platform includes processes operating in J2SE (Java 2 Standard Edition) and J2EE (Java 2 Enterprise Edition).

In the specific context of a program utilizing the SSL protocol, the illustrated process may be manifested in a reuse of byte arrays (which may be referred to as SSLBuffer's) by means of a special framework that consists of the following components: (a) a special SSLBuffer interface to access the buffers from the SSL connections and (b) the SSLBufferPool mechanism, which manages the buffers, determines the number of allocated buffers and provides these buffers to the SSL connections as needed.

In conventional operations, an application that requires a temporal buffer for a particular operation utilizes a temporal buffer that is allocated by the execution environment for the operation. However, this means that many operations are repeated, such as when the process involves a security protocol, and thus a very large number of temporal buffers will be required. In Java programming it is generally not possible to deallocate used temporal buffers immediately, and thus such data remains allocated. In one practical example, if 100 threads are run, with each thread executing SSL protocol, then each transaction of SSL protocol will use two temporal buffers, with each buffer requiring an average of 10 KB of memory. If garbage collection starts every three seconds, then after three seconds the application will take up at least 100×2×10 KB≈2 MB of redundant memory waiting for erasure. In an embodiment of the invention, a memory buffer is implemented into a system to allow reuse of the memory buffers such that a new memory buffer does not need to be generated for each operation. The number of allocated buffers will be reduced because of the buffer reuse, and may be expected in practice to be roughly one-tenth of the number required for conventional operations, or roughly 10×2×10 KB≈0.2 MB. In addition, CPU time spent on buffer allocation will be reduced because the buffers that are allocated will be reused by the threads.

In an embodiment of the invention, a system may operate either with or without garbage collection. If an execution environment has garbage collection, buffers will be deleted by the garbage collector after the last thread using the buffer pool ends. In the case of an execution environment without garbage collection, a thread using the buffer pool should unregister from the pool after completing use of it. For example:

buffer_pool=BufferPool.getInstance(max_size);

. . . // use of the buffer is conducted

buffer_pool.release( )
or

unregister( );

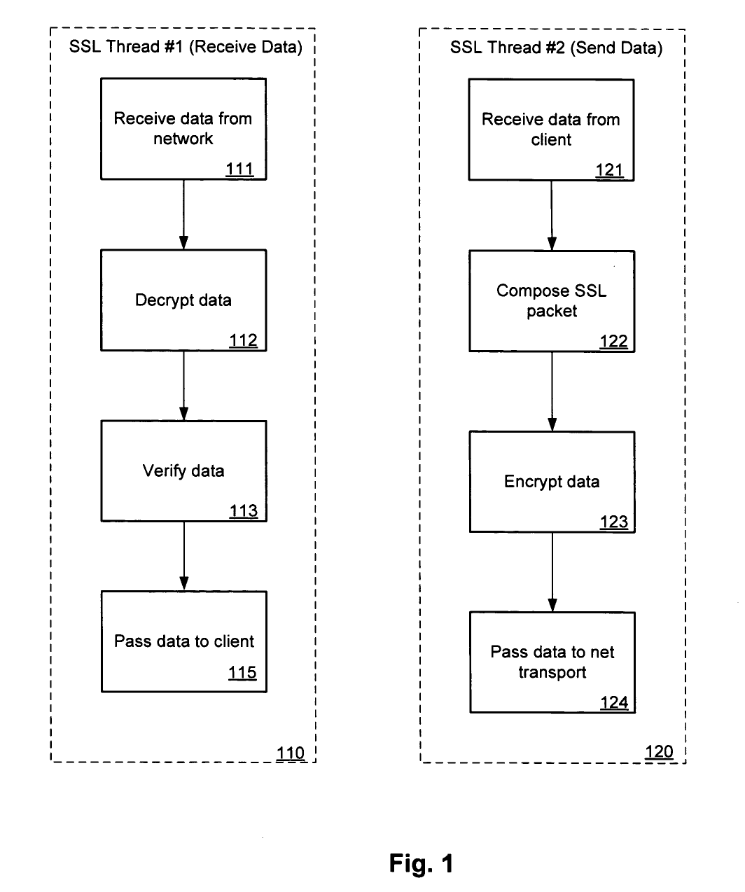

FIG. 1 is a block diagram illustration of an embodiment of processes for two threads in a multi-threaded application. In this illustration, a first thread provides for receiving data 110 and a second thread provides for sending data 120. While only two threads are illustrated, numerous additional threads may also be active in the application. For incoming data, thread 110 includes receiving data from the network 111 and decrypting the received data 112. The thread then provides for performing verification of received data 113 and delivering it to the client 115 (handshake protocol or client's application data stream). For the outgoing data thread 120, data is received from the client's stream 121 and an SSL data packet is formed 122. The data packet is encrypted for transmission 123, and the encrypted data packet is passed to the network transport 124.

The TSL/SSL protocol implementation in Java may utilize large byte arrays with each of these processes. The processes of receiving data from the network 111, decrypting the received data 112, generating the SSL packet 122 and encrypting the data packet 123 will each instance a byte array. Further, the allocation of these arrays requires additional CPU processing time, which reduces system performance. This problem may be compounded by multiple and simultaneous TLS/SSL connections, which can cause significant memory consumption and potentially may disrupt or cause a crash of the operation of the system. In an embodiment of the invention, the first thread 110 and the second thread 120 share a buffer pool to obtain the memory buffers needed for the processes, wherein the first thread 110 and the second thread 120 may reuse the same buffers as needed.

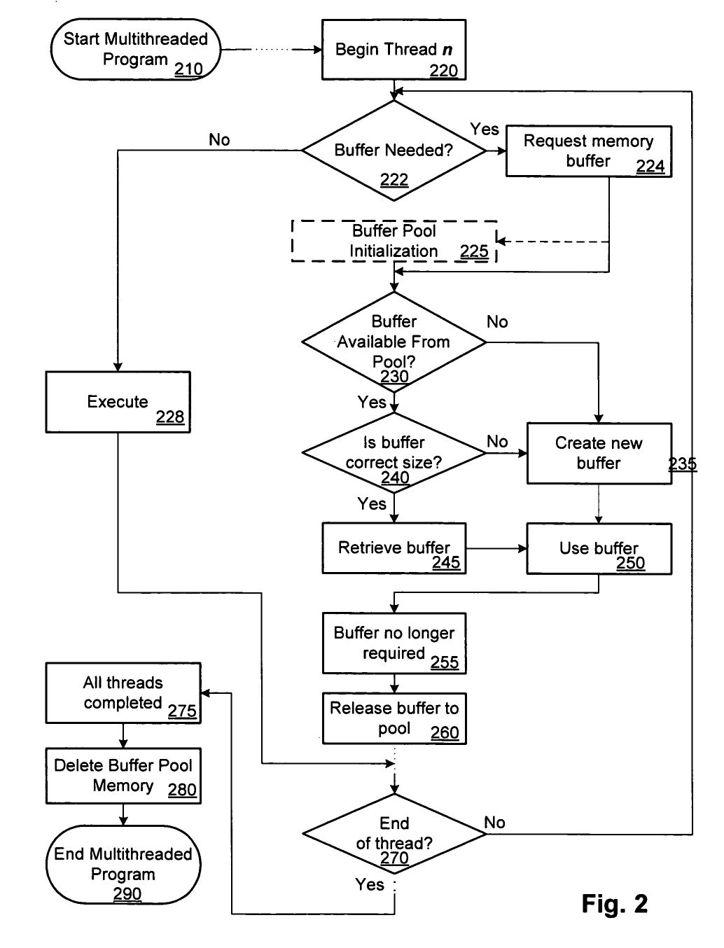

FIG. 2 is a flowchart to illustrate an embodiment of the provision of memory buffers to a computer program. In this example, a multi-threaded program is started 210, with the computer program utilizing multiple temporal memory buffers in operation. The computer program may include security transactions, including transactions utilizing SSL protocol. In this illustration, a thread n is instanced from the multi-threaded program 220. The program thread may require a memory buffer 222 in order to execute an operation. If not, then the operation can be executed 228. If a memory buffer is required, then a request for a buffer is made to the buffer pool 224. The request may include a requested size for the memory buffer. If the buffer pool does not exit, such as because the request is the first request for a memory buffer that has been made for the program, then the buffer pool is initialized. There is a determination whether a memory buffer is available in the buffer pool 230 of the correct size 240. If not, then a new memory buffer is allocated 235. If a buffer is available, the buffer is retrieved for the use of the thread 245. The allocated or obtained buffer is then used in the operation 250 as required. After the end of the operation, the buffer is no longer required 255, and is released back to the buffer pool 260.

When the thread has ended 270, the buffer pool may be retained, with the memory buffers contained in the pool being available for operations by other program threads. When all threads of the computer program are completed 275 or there are otherwise no more active operations that would require use of the memory buffers held by the buffer pool, the buffer pool is deleted 280, and the memory buffers may then be subject to garbage collection. The execution of the program may then be ended 290. While this illustration provides a certain sequence of processes, embodiments of the invention are not limited to this sequence, and may be implemented in a different manner. For example, the buffer pool initialization 225 may occur prior to any request for a memory buffer is made in order to anticipate the receipt of the memory buffer requests. In another example, the buffer pool may perform certain management operations in connection with the stored memory buffers after release of the buffers back to the pool 260.

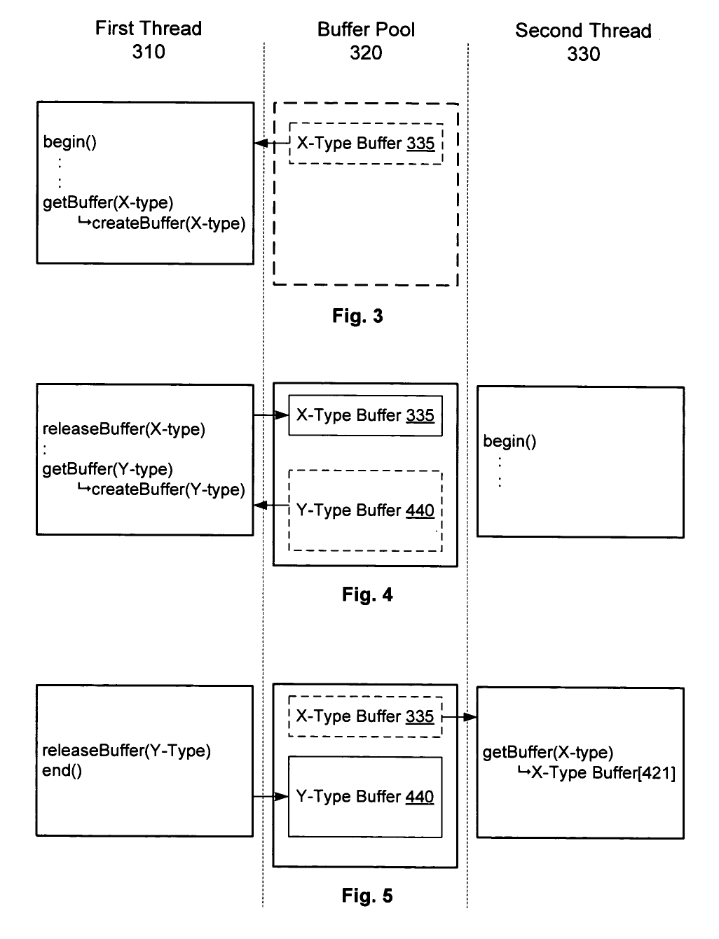

FIGS. 3-7 are block diagrams to illustrate embodiments of operations of a multi-threaded computer programs. In these diagrams, the program instructions are shown inside the blocks representing a first thread 310 and a second thread 330. Illustrated between the threads is a buffer pool 320. The commands shown within the blocks are specific to this particular embodiment and are not required for other embodiments of the invention. Each thread may require multiple different memory buffer types, such as the illustrated X-type and Y-type buffers. For example, X-type and Y-type buffers may be buffers of different sizes.

FIG. 3 illustrates an embodiment of a thread making an initial request for a memory buffer. In this illustration, the first thread 310 includes executing a block of code that requiring an X-type buffer. Buffer pool 320 manages the use of these buffers once they have been instanced. In this case, the buffer request is the first request made and the buffer pool is created. The buffer pool generates an X-type buffer 335 for the use of the first thread 310.

FIG. 4 illustrates an embodiment of a thread releasing a memory buffer and requesting a second memory buffer. In this illustration, the first thread 310 has completed execution of a process, and thus no longer needs X-type buffer 335. First thread 310 releases X-type buffer 335 to the buffer pool 320. First thread 310 further begins execution of a process requiring a Y-type buffer 440, and makes a request for such a buffer. Buffer pool 320 does not contain a Y-type buffer and thus a Y-type buffer 440 is allocated to the first thread 320.

FIG. 5 illustrates an embodiment of a second thread retrieving a memory buffer previously released by a first thread. In this illustration, the first thread 310 has completed an operation and releases the Y-type buffer 440 to the buffer pool 320. In addition the second thread 330 is executing an operation that requires an X-type buffer. Because there is now an X-type buffer 335 in the buffer pool 320 no new memory buffer needs to be instanced, and buffer 335 is provided to the second thread 330 for use.

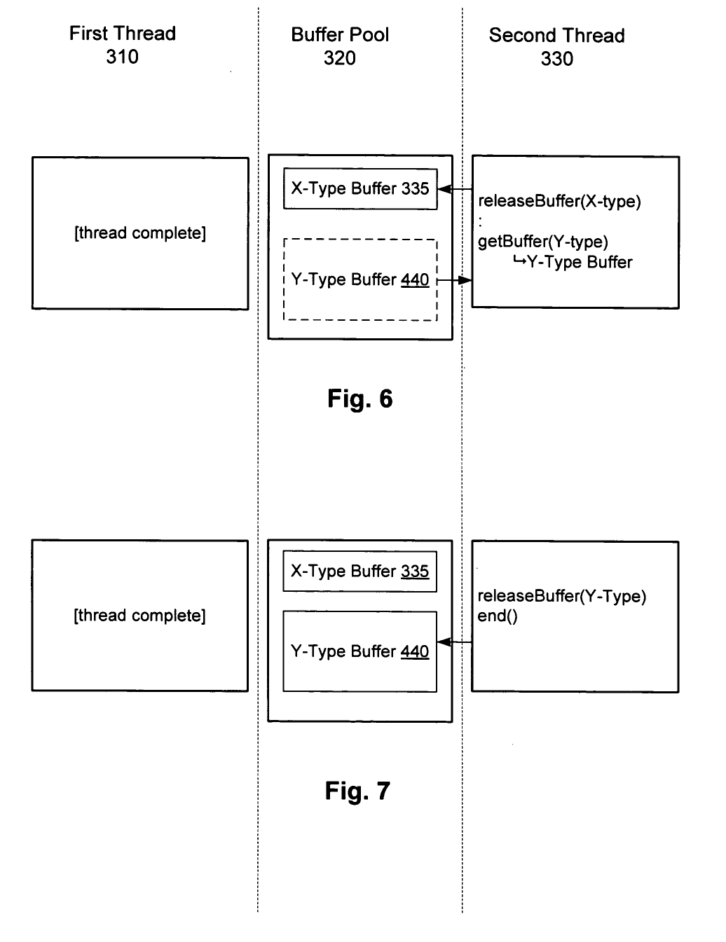

FIG. 6 illustrates an embodiment of a second thread releasing a first buffer to a buffer pool and reusing a second buffer from the buffer pool. As illustrated, the second thread 330 is has completed the operation requiring the X-type buffer 335, and again releases the buffer to the buffer pool 320 for further use. In addition the second thread 330 executes an operation requiring a Y-type buffer. A Y-type buffer 440 is available in the buffer pool 320, and it is provided to the second thread 330 for use.

FIG. 7 illustrates an embodiment of a buffer pool after active threads have finished executing. In this illustration, the second thread 330 releases the Y-type buffer 440 to the buffer pool 320. The buffer pool now contains two memory buffers 335 and 440, which can be used in subsequent threads of the multi-threaded program. The memory in the buffer pool 320 may then be deallocated when all threads of the multi-threaded program have ended or the memory buffers are no longer needed.

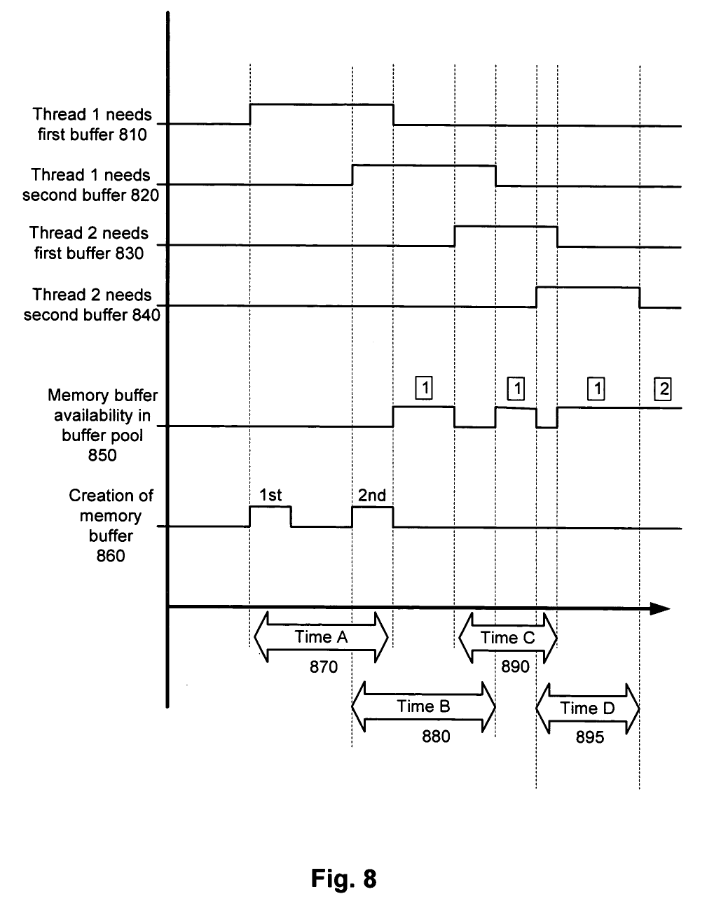

FIG. 8 is a line graph illustrating the time and resource usage of a multi-threaded program in an embodiment of the invention. In this example, thread 1 and thread 2 are each running a sequence of instructions that require the use of memory buffers, two buffers for each in this case. For simplicity it is assumed that the memory buffers allocated are the same, such as all being the same size, but similar examples can be provided for memory buffers that are of different size or vary in other ways.

As illustrated, the time periods for which the buffers are needed are shown in signals 810 and 820 for thread 1 and 830 and 840 for thread 2. The time periods could overlap, thus requiring additional buffers, or may not overlap, thus allowing the reuse of memory buffers. Thread 1, as shown in 810, requires a first buffer 810 for the period Time A 870 and, as shown in 820, requires a second buffer during the period Time B 880, which partially overlaps with Time A 870. Thread 2, as shown in 830, requires a first buffer during the period Time C 890, and a second buffer during the period Time D 895. As shown, Time C 880 partially overlaps with Time B 880 and with Time D 895. However, despite the overlaps in time periods, only two memory buffers are needed. The buffer pool availability 850 is initially zero and thus a first memory buffer is allocated 860 at the beginning of Time A 870 to provide to Thread 1. When thread 2 requires a second buffer at the beginning of Time B 880, a second buffer is allocated 860. However, a memory buffer is released at the end of Time A 870, thus increasing the number of buffers in the buffer pool 850 to one. The available buffer is provided to Thread 2 at the beginning of Time C 890, thus preventing the need for allocation of a third buffer. The availability of buffers 850 again is zero, but a buffer is released from Thread 1 at the end of Time B 880, returning the number available 850 to one. The available buffer is provided to Thread 2 at the beginning of Time D 895, with the buffers being released by Thread 2 at the end of Time C 890 and Time D 895. Thus, even though the time periods for buffers overlapped and even though each program thread needed two buffers at certain times, only two buffers were required. The example provided in the figure can be expanded to any number of threads, with the number of buffers that are allocated being limited to the maximum that will be needed at any time in the process.

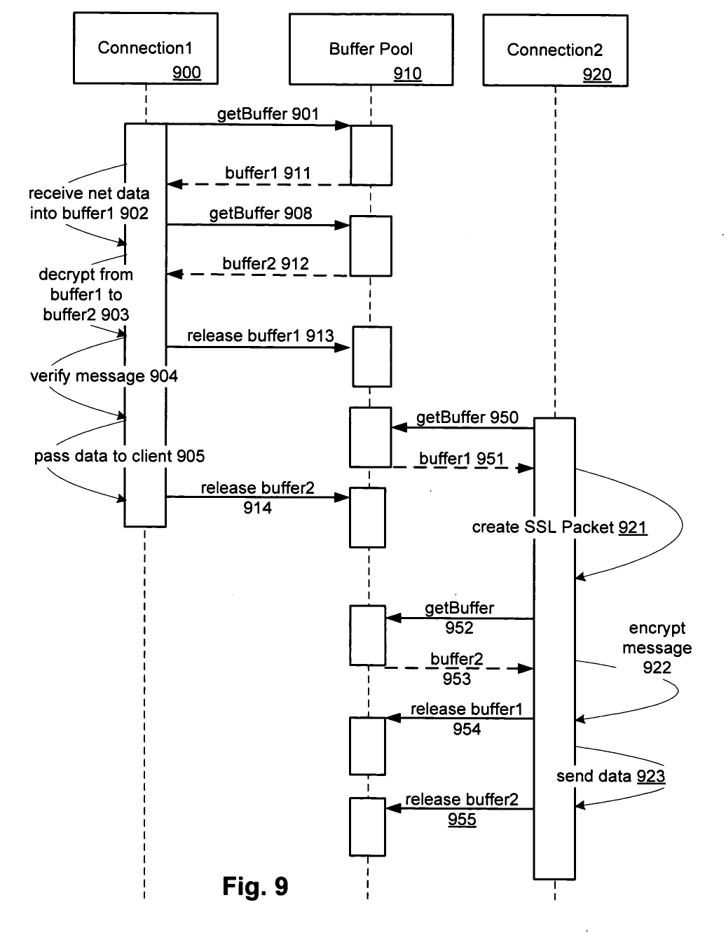

FIG. 9 is an illustration of multiple SSL connections utilizing an embodiment of a buffer pool. As illustrated, an application includes a first connection, Connection1 900, involved with receiving data and a second connection, Connection2 920, involved with sending data. Both collections are utilizing a buffer pool 910 to obtain required memory buffers for operation. As shown, Connection1 900 requests (getBuffer 901) a buffer, and receives buffer1 911, which is unitized for receiving network data 902. If a memory buffer was not available in the buffer pool 910, the buffer pool would have allocated a memory buffer for the connection. Connection1 900 makes another request for a buffer 908, and obtains buffer2 912 for use in decrypting the received data 903. A request to release buffer1 is made 913. Connection1 900 then verifies the received message 904, and passes the data on to the client 905. During this time Connection2 920 requests a memory buffer 950, and receives buffer1 951, which had been released to the buffer pool 910. The buffer1 is used in the creation of an SSL packet 921. During this time, Connection1 900 releases buffer2 back to the buffer pool 914. Connection2 920 then makes another request for a memory buffer 952, and receives the previously released buffer2 953, which is used to encrypt the SSL message 922. After this Connection2 920 can release buffer1 954, send the encrypted data 923, and release buffer2 955.

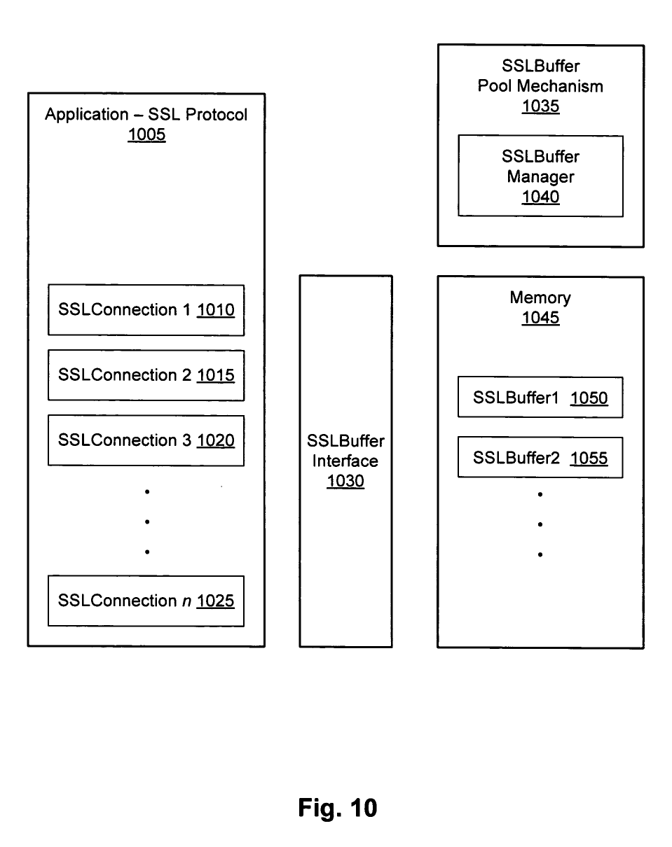

FIG. 10 is an illustration of an embodiment of a buffer pool for SSL transactions. In this illustration, an application 1005 operates utilizing SSL protocol, in which multiple SSL connections may be implemented. The application 1005 includes, but is not limited to, an application running on a Java platform. The SSL connections are illustrated as SSLConnection 1 1010, SSLConnection 2 1015, SSLConnection 3 1020, and continuing through SSLConnection n 1025. However, the connections do not necessarily exist at the same time, as connections will be implemented and end as required. An SSLBuffer pool mechanism 1035, which may include an SSLBuffer manager 1040, manages and determines the number of memory buffers for the use of the SSLConnections 1010-1025. The memory buffers are illustrated in memory 1045 as SSLBuffer 1 1050 and SSLBuffer 2 1055, together with any other buffers that may be allocated. The SSLBuffers may be organized in different ways in different embodiments of the invention, including as a linked list or as a tree structure. In an embodiment of the invention, the SSLBuffer pool mechanism will allocate the memory buffers as needed to support the connections, with the buffers remaining in memory when not actively allocated to connections. An SSLBuffer interface 1030 is provided to allow access to the SSLBuffers from the SSL connections.

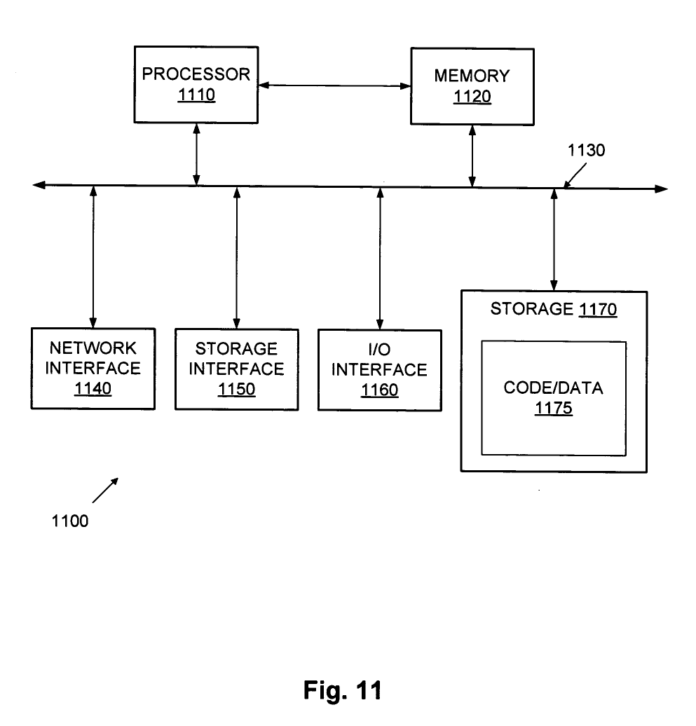

FIG. 11 is a block diagram of an embodiment of a computer system to implement an embodiment of a buffer pool. The computer system diagram is limited to relevant components and does not include all elements that may be included in a system. The computer system 1100 includes one or more processors 1110, which may represent physical or logical processors. Processor 1110 may include any type of microprocessor, central processing unit (CPU), processing core, etc., to perform operations including operation related to message authentication and servicing of data access requests. In an embodiment of the invention, the processor 1110 controls the execution of a buffer pool to provide memory buffers for operations of a computer application. The system also includes memory 1120, which may be coupled to the processor 1110. The memory 1120 may include multi-threaded program that utilizes memory buffers, as well as including the buffer pool. Memory 1120 may include read-only memory (ROM), flash memory, one or more varieties of random access memory (RAM, e.g., static RAM (SRAM), dynamic RAM (DRAM), synchronous DRAM (SDRAM), etc.), or a combination of memory technologies.

Processor 1110 and memory 1120 are coupled to bus system 1130. Bus system 1130 is an abstraction that represents any of one or more separate physical buses, communication lines/interfaces, or multi-drop or point-to-point connections, connected by appropriate bridges, adapters, or controllers. The bus system 1130 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronic Engineers (IEEE) standard 1394-1995 bus, published Aug. 30, 1996, commonly refereed to as “Firewire.”

The computer system 1100 may further include one or more network interfaces 1140, one or more storage interfaces or adapters 1150, one or more input/output (I/O)) interfaces 1160, and one or more internal storage device(s) 1170. Network interface 1140 may be used with a multi-threaded program based at least in part on the SSL protocol. Internal storage 1170 may be or include any conventional medium for storing data in a non-volatile manner. Storage 1170 includes code or data 1175 that may be accessed and placed in memory 1120 for execution by processor 1110.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
executing a computer program, the computer program including one or more threads;
creating a buffer pool to hold one or more memory buffers for the operation of the computer program;
receiving a request for a memory buffer from a thread of the computer program; and
providing a memory buffer from the buffer pool to the thread in response to the request if a memory buffer is available in the buffer pool.

2. The method of claim 1, further comprising allocating a memory buffer in response to the request if a memory buffer is not available in the buffer pool.

3. The method of claim 1, wherein the allocation of the buffer pool is done in response to a first request for a memory buffer.

4. The method of claim 1, further comprising releasing the memory buffer to the buffer pool after use of the memory buffer is completed.

5. The method of claim 4, further comprising providing the released memory buffer to another thread.

6. The method of claim 1, wherein the computer program utilizes SSL (Secure Sockets Layer) protocol.

7. The method of claim 1, wherein the computer program is executed on a Java platform.

8. The method of claim 1, wherein the buffer pool comprises one of a linked list or a tree structure.

9. The method of claim 1, wherein the buffer pool contains at least a first memory buffer and a second memory buffer, wherein the first memory buffer and the memory temporal buffer may be of different sizes.

10. An apparatus comprising:
a computer application, the application including a plurality of threads;
a buffer pool mechanism, the buffer pool mechanism to allocate memory buffers for the computer application; and
a memory buffer storage, the memory storage providing storage for one or more memory buffers, the memory buffers remaining in the memory buffer storage when not in use.

11. The apparatus of claim 10, wherein the buffer pool mechanism includes a buffer manager to manage the operation of the memory buffer storage.

12. The apparatus of claim 10, wherein the buffer pool mechanism provides a memory buffer to a thread of the application upon receipt of a request for a memory buffer.

13. The apparatus of claim 12, wherein the buffer pool mechanism allocates a memory buffer if a memory buffer is not available in the buffer pool for the request.

14. The apparatus of claim 12, wherein the provided memory buffer is released to the buffer pool after use of the memory buffer by the thread has ended.

15. The apparatus of claim 12, wherein a request for a memory buffer includes a requested size for the memory buffer.

16. The apparatus of claim 10, further comprising an interface to provide access to the memory buffers from the plurality of threads.

17. The apparatus of claim 10, wherein each thread comprises an SSL connection.

18. A computer system comprising:
a bus;
a dynamic random access memory coupled to the bus, the memory including:
a multi-threaded computer program, and
a buffer pool to hold one or more temporal buffers for the use of the computer program, the temporal buffers to remain in the buffer pool when not in use; and
a processor to execute the computer program.

19. The system of claim 18, wherein the buffer pool is to provide a temporal buffer to a thread of the computer program upon request.

20. The system of claim 19, wherein the buffer pool is to receive a temporal buffer from a thread upon completion of use of the temporal buffer.

21. The system of claim 18, wherein the buffer pool is deallocated when all threads of the computer program are completed.

22. The system of claim 18, wherein the computer program utilizes a SSL (Secure Sockets Layer) protocol.

23. A machine-readable medium having stored thereon data representing sequences of instructions that, when executed by a machine, cause the machine to perform operations comprising:
executing a computer application, the computer program including one or more threads;
creating a buffer pool to hold one or more memory buffers for the operation of the computer program;
receiving a request for a memory buffer from a thread of the computer program; and
providing a memory buffer from the buffer pool to the thread in response to the request if a memory buffer is available in the buffer pool if a memory buffer is available in the buffer pool.

24. The medium of claim 23, further comprising instructions that, when executed by the machine, cause the machine to perform operations comprising:
allocating a memory buffer in response to the request if a memory buffer is not available in the buffer pool.

25. The medium of claim 24, further comprising instructions that, when executed by the machine, cause the machine to perform operations comprising;
releasing the memory buffer to the buffer pool after use of the memory buffer is completed.

26. The medium of claim 23, wherein the computer program utilizes SSL (Secure Sockets Layer) protocol.
